(19) United States
(12) Patent Application Publication
(10) Pub. No.: US 2013/0119235 A1
(43) Pub. Date: May 16, 2013

(54) SOLID-STATE IMAGING APPARATUS AND METHOD FOR DRIVING SOLID-STATE IMAGING APPARATUS

(71) Applicant: CANON KABUSHIKI KAISHA, Tokyo (JP)

(72) Inventor: Satoko Iida, Yokohama-shi (JP)

(73) Assignee: CANON KABUSHIKI KAISHA, Tokyo (JP)

(21) Appl. No.: 13/627,537

(22) Filed: Sep. 26, 2012

(30) Foreign Application Priority Data
Nov. 14, 2011 (JP) 2011-249004

(51) Int. Cl. H01L 27/146

(52) U.S. Cl. 250/208.1

(57) ABSTRACT

A solid-state imaging apparatus includes: a plurality of pixels each configured to output a signal generated by a photoelectric conversion via a source follower circuit; an output line connected to the plurality of pixels; a current source circuit portion for supplying a current to the output line; and a first amplifier unit configured to clamp a signal from the output line of the pixel at a reset state to a clamping capacitor, and to amplify thereafter the signal from the output line of the pixel at a non-reset state, wherein the current source circuit portion changes from a state of supplying no current to the output line to a state of supplying the current to the output line before a timing of terminating the clamping of the signal.

### BACKGROUND OF THE INVENTION

1. Field of the Invention

The present invention relates to a solid-state imaging apparatus.

2. Description of the Related Art

In recent years, with a trend toward increasing numbers of pixels in a solid-state imaging apparatus, the power consumption thereof has increased. The solid-state imaging apparatus described in Japanese Patent Application Laid-Open No. H08-018866 reduces an electric power to be consumed in the apparatus, by restricting and/or intercepting an electric current to be passed through a constant current source for source follower read-out, in periods other than a period during which a read-out transistor in each pixel performs a read-out operation.

### SUMMARY OF THE INVENTION

However, the solid-state imaging apparatus needs a certain amount of time, when returning to a read-out operation, after having restricted or blocked the electric current which flows in the constant current source before the electric current of the constant current source reaches a desired value of the electric current. This delay of the operation originates in a parasitic capacitance that sticks to the constant current source, which is a key factor. In addition, this constant current source is provided in one end of a vertical output line, and a difference occurs in video signals to be read between a pixel close to and a pixel distant from the constant current source, due to the resistance component in the vertical output line. Particularly, if the above described constant current source is not used in such a state that the electric current is sufficiently stabilized, there is a possibility of generating shading in a vertical direction to the read signal.

According to an aspect of the present invention, in order to solve the above problem, a solid-state imaging apparatus comprises: a plurality of pixels each configured to output a signal generated by a photoelectric conversion via a source follower circuit; an output line connected to the plurality of pixels; a current source for supplying a current to the output line; and a first amplifier unit configured to clamp with a clamping capacitor a signal from the signal line connected to the pixel at a reset state, and to amplify thereafter the signal from the signal line connected to the pixel changed to a non-reset state, wherein the current source changes from a current non-supplying state to a current supplying state, before a timing of terminating the clamping the signal by the first amplifier unit.

Further features of the present invention will become apparent from the following description of exemplary embodiments with reference to the attached drawings.

### BRIEF DESCRIPTION OF THE DRAWINGS

FIG. 1 is a block diagram illustrating a configuration example of a solid-state imaging apparatus of a first embodiment.

FIG. 2 is a view illustrating a detailed configuration example of the first embodiment.

FIG. 3 is a driving timing chart of the first embodiment.

FIG. 4 is a view illustrating a detailed configuration example of a second embodiment.

FIG. 5 is a driving timing chart of the second embodiment.

FIG. 6 is a block diagram illustrating a configuration example of a solid-state imaging apparatus of a third embodiment.

FIG. 7 is a view illustrating a detailed configuration example of a fourth embodiment.

FIG. 8 is a driving timing chart of the fourth embodiment.

FIG. 9 is a view illustrating a detailed circuit configuration example of a fifth embodiment.

FIG. 10 is a timing chart illustrating an operation example of a solid-state imaging apparatus of the fifth embodiment.

### DESCRIPTION OF THE EMBODIMENTS

Preferred embodiments of the present invention will now be described in detail in accordance with the accompanying drawings.

### First Embodiment

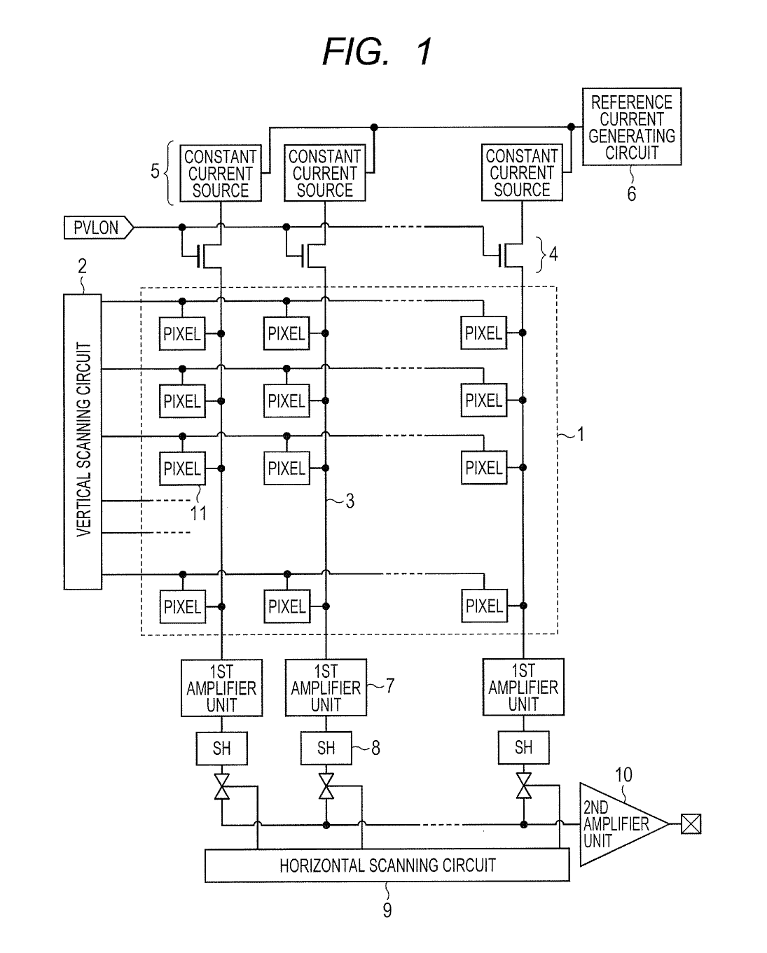

FIG. 1 is a block diagram illustrating a configuration example of a solid-state imaging apparatus of a first embodiment of the present invention. The solid-state imaging apparatus includes: a pixel array 1; a vertical scanning circuit 2; a constant current source circuit unit 5; a reference current generating circuit 6; a first amplifier unit 7; a sampling and holding circuit 8; a horizontal scanning circuit 9; and a second amplifier unit 10. The constant current source circuit unit 5 is connected to one end of a vertical output line 3 through a control switch 4 of the constant current source, and supplies an electric current to the vertical output line 3. The reference current generating circuit 6 determines a current value. In the pixel array 1, unit pixels 11 are two-dimensionally arrayed so as to form a plurality of rows and a plurality of columns. The plurality of the unit pixels 11 in each column are connected to the respective vertical output lines 3. The signal which has been read from the pixel array 1 is amplified by the first amplifier unit 7, and is held in the sampling and holding circuit 8. The first amplifier unit 7 and the sampling and holding circuit 8 may be provided for every single column or may be provided for every plurality of columns. The vertical scanning circuit 2 is formed, for instance, of a shift register, and selects the row of the pixel array 1. The horizontal scanning circuit 9 also is formed, for instance, of a shift register, and applies a pulse by which the second amplifier unit 10 sequentially reads the signals which have been held in the sampling and holding circuits 8, to the sampling and holding circuits 8.

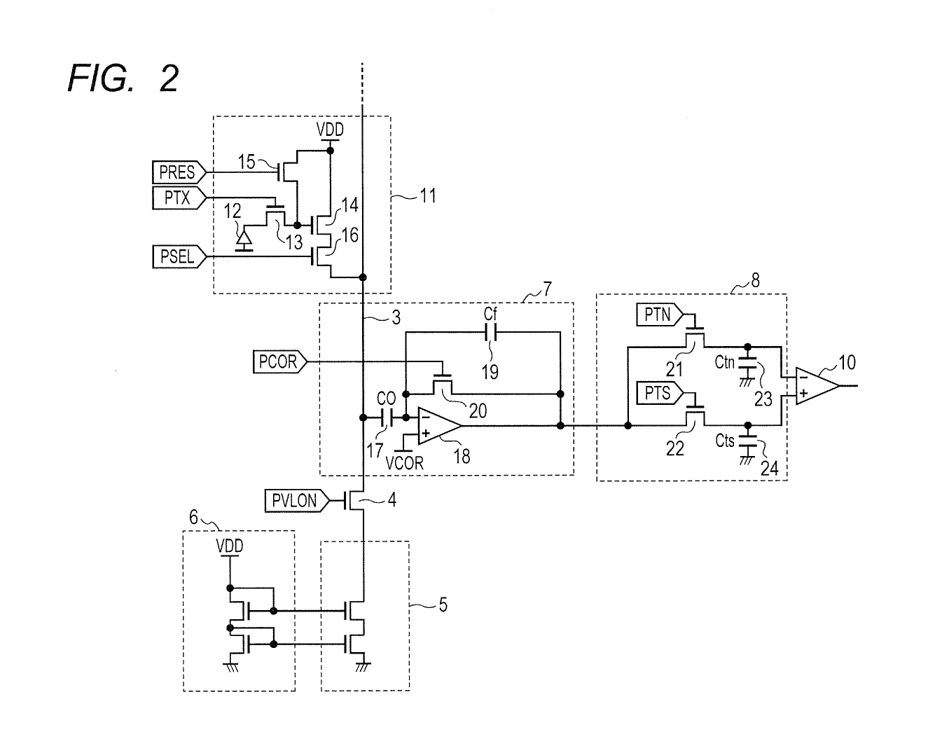

FIG. 2 is a view illustrating a detailed configuration example of the unit pixel 11, the first amplifier unit 7, the sampling and holding circuit 8, the constant current source circuit unit 5 and the reference current generating circuit 6 of FIG. 1. The unit pixel 11 includes: a photoelectric conversion unit 12; a transfer MOS transistor 13; a source follower MOS transistor (hereinafter referred to as SFMOS transistor) 14; a reset MOS transistor 15; and a row selecting MOS transistor 16. The photoelectric conversion unit 12 generates a signal by photoelectric conversion. The transfer MOS transistor 13 transfers the signal which has been generated in the photoelectric conversion unit 12. The SFMOS transistor 14 amplifies the signal which has been transferred by the transfer MOS transistor 13. The reset MOS transistor 15 resets the input of the gate electrode of the SFMOS transistor 14 to a predetermined potential. The row selecting MOS transistor 16 is provided between the source electrode of the SFMOS transistor 14 and the vertical output line 3, and controls conduction between the source electrode of the SFMOS transistor 14 and the vertical output line 3.

The vertical output line 3 is connected to the first amplifier unit 7. The first amplifier unit 7 amplifies the signal which has been output to the vertical output line 3. The first amplifier unit 7 includes: a clamping capacitor (C0) 17; an inverting amplifier 18; and a feedback capacitor (Cf) 19. In addition, a reference potential VC0R is applied to the non-inverting input terminal of the inverting amplifier 18. When a clamping switch 20 is turned on by a clamp pulse PC0R, both ends of the feedback capacitor (Cf) 19 are short-circuited, and the potential of the vertical output line 3 with respect to the reference voltage VC0R is held by the clamping capacitor (C0)17. The output end of the first amplifier unit 7 is connected to a holding capacitance (Ctn) 23 through a control MOS transistor 21 which controls connection in the sampling and holding circuit 8, and is similarly connected to a holding capacitance (Cts) 24 through a control MOS transistor 22. The holding capacitance (Ctn) 23 holds an N signal (that is approximately VC0R) which is an offset voltage of the inverting amplifier 18 with respect to the reference voltage VC0R, and the holding capacitance (Cts) holds a pixel signal which has been obtained by superimposing an optical signal on the N signal. Furthermore, the signals which have been temporarily held in the holding capacitance (Ctn) 23 and the holding capacitance (Cts) 24 are sequentially read by the horizontal scanning circuit 9, are differentially amplified by the second amplifier unit 10, for instance, and are output to the outside as an optical signal. The constant current source circuit unit 5 is formed of a cascode current mirror using an NMOS transistor, together with the reference current generating circuit 6. In addition, the constant current source circuit unit 5 supplies a desired current to a source follower circuit which includes the selected row selecting MOS transistor 16 and the SFMOS transistor 14, through the vertical output line 3 by the control switch 4 of the constant current source, and makes a reading operation of the pixel signal effective. The constant current source circuit unit 5 is arranged in each column, and supplies an electric current which has been set by the reference current generating circuit 6, to the source follower circuit. Even if the row selecting MOS transistor 16 has not been selected, a constant current may be supplied to the vertical output line 3 from another circuit (of which the figure is omitted) which is connected to the vertical output line 3.

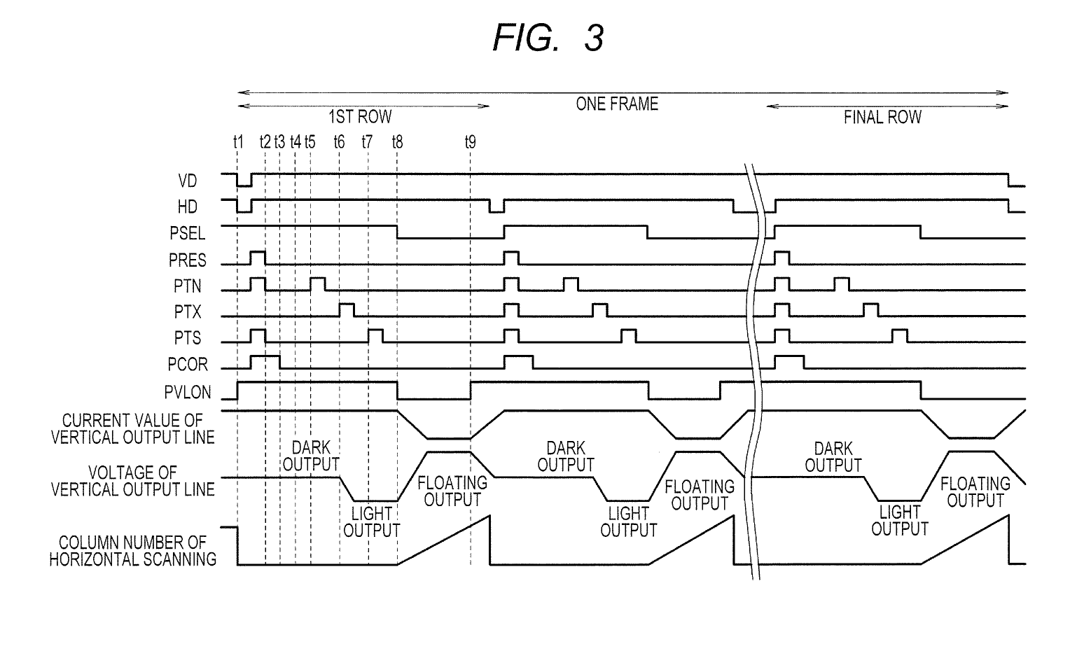

FIG. 3 is a timing chart illustrating an operation example of the solid-state imaging apparatus illustrated in FIG. 1 and FIG. 2. In addition, FIG. 3 illustrates the column number of horizontal scanning, which is controlled by the horizontal scanning circuit 9, the change of the potential of the vertical output line 3, and the change of an electric current which passes through the vertical output line 3, collectively. A vertical synchronizing signal VD specifies a unit section for obtaining an image signal for one frame. A horizontal synchronizing signal HD specifies a unit section for illustrating one horizontal line. Here, each signal is input into both at the time t1, in the beginning. The signal PRES becomes a high level, the reset MOS transistor 15 is turned ON, and the unit pixel 11 is turned into a reset state. In addition, the clamp pulse PC0R becomes a high level, the clamping switch 20 is turned ON, thereby the inverting amplifier 18 is turned into a voltage follower state, and the electrode in the inverting amplifier 18 side of the clamping capacitor (C0)17 becomes approximately a VC0R voltage. Thereby, the first amplifier unit 7 starts an operation of clamping the signal (potential) of the vertical output line 3 in such a state that the unit pixel 11 is reset, to the clamping capacitor 17. The signal PTN becomes a high level, the control MOS transistor 21 is turned ON, and thereby an approximate VC0R voltage is written in the holding capacitance 23. In addition, the signal PTS becomes a high level, the control MOS transistor 22 is turned ON, and thereby the approximate VC0R voltage is written in the holding capacitance 24.

Firstly, at the time t2, the signal PRES becomes a low level from the high level, the reset MOS transistor 15 is turned OFF from ON, the reset state of the gate electrode of the SFMOS transistor 14 is cleared, and the unit pixel 11 is turned into a non-reset state. At this time, a potential corresponding to a dark time is fixed on the gate electrode of the SFMOS transistor 14. Then, at the time t3, the clamp pulse PC0R becomes a low level from the high level, and the clamping switch 20 is turned OFF from ON. Thereby, the first amplifier unit 7 finishes the operation of clamping the signal (potential) of the unit pixel 11 in the reset state sent from the vertical output line 3, to the clamping capacitor 17. In the clamping operation, the signal PSEL is in a high level and the row selecting MOS transistor 16 is turned ON; and accordingly the dark output of the pixel 11 exists in the vertical output line 3 and is clamped by the clamping capacitor (C0)17. After the clamping operation has been finished, the first amplifier unit 7 amplifies the signal of the vertical output line 3.

Subsequently, at the time t5, the signal PTN becomes a high level, the control MOS transistor 21 is turned ON, and thereby the holding capacitance 23 holds the N signal which is an output voltage of the inverting amplifier 18. Subsequently, at the time t6, the signal PTX becomes a high level, the transfer MOS transistor 13 is turned ON, and a photoelectric charge which has been accumulated in the photoelectric conversion unit 12 is transferred to the gate electrode of the SFMOS transistor 14.

After that, at the time t7, the signal PTS becomes a high level, the control MOS transistor 22 is turned ON, and thereby the holding capacitance 24 holds a pixel S signal which has been obtained by superimposing an optical signal on the N signal. In addition, the control switch 4 of the constant current source is turned ON by the signal PVLON at the time t1 before the time t3 of terminating the clamping of the signal, and an electric current is supplied to the vertical output line 3. In other words, the constant current source circuit unit 5 changes from a state of supplying no current to the vertical output line 3 to a state of supplying the current to the vertical output line 3 at the time t1 before the time t3 of terminating the clamping of the signal, by the control switch 4 of the constant current source. In the present embodiment, at the time t9 (=t1) in a period when the previous row is horizontally scanned, the control switch 4 of the constant current source is turned ON. Thereby, the SFMOS transistor 14 of the pixel is turned into a sufficiently stable state before the time t3 when the clamping capacitor 17 clamps the potential of the vertical output line 3. The timing of turning the control switch 4 of the constant current source ON is appropriately determined by the parasitic capacitance which sticks to the constant current source circuit unit 5, and by the number of the pixels. In addition, a method of adjusting the timing of turning the control switch 4 of the constant current source ON is not only a method of synchronizing the timing with the pulse sent from a timing generator, but also may be a method, for instance, of using a value to be obtained by counting the pulses sent from the horizontal scanning circuit 9.

Thereby, the potential of the vertical output line 3 becomes sufficiently stable before the above described clamping operation is finished and the optical signal is held, though the potential of the vertical output line 3 rapidly changes simultaneously with the current supply operation of the constant current source circuit unit 5, and accordingly the solid-state imaging apparatus and the method for driving the solid-state imaging apparatus can prevent a problem such as vertical shading. Incidentally, at this time, a stabilization time of the constant current source circuit unit 5 depends on the number of the horizontal pixels, the size of the transistor in the constant current source circuit unit 5 and the like, but it is appropriate to turn ON the switch 4 of the constant current source approximately 1μ second or more before the time t3, as a guide. In other words, the constant current source circuit unit 5 can change the states from the state of supplying no current to the vertical output line 3 to the state of supplying the current to the vertical output line 3, at least 1μ second before the time t3 of terminating the clamping of the signal.

### Second Embodiment

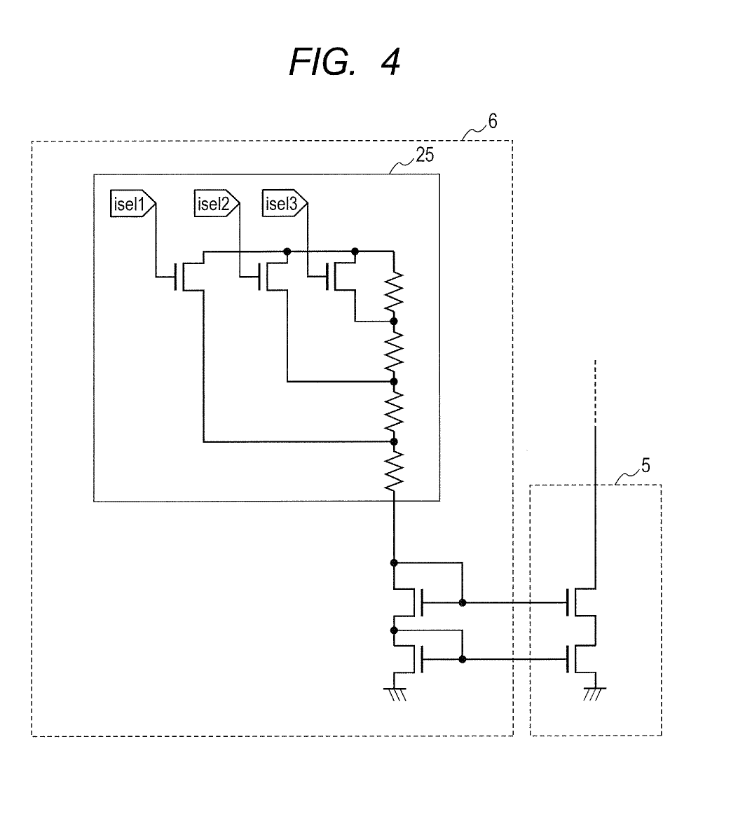

The configuration of the solid-state imaging apparatus of the second embodiment of the present invention is the same as that of FIG. 1 described in the first embodiment, and accordingly the description will be omitted. FIG. 4 is a view illustrating a configuration example of a reference current generating circuit 6 according to the second embodiment, and is different from the first embodiment of FIG. 2 in a part that a current value selector circuit 25 is provided in the reference current generating circuit 6. Thereby, the solid-state imaging apparatus can control the value of the constant current in each pixel column in steps. The current value selector circuit 25 may control the electric current by varying the constant current by dividing the resistance, or may also switch among power sources themselves. FIG. 4 illustrates a circuit example of the current value selector circuit 25. Here, the current value selected from a signal isel 1, isel 2 and isel 3 can be appropriately set.

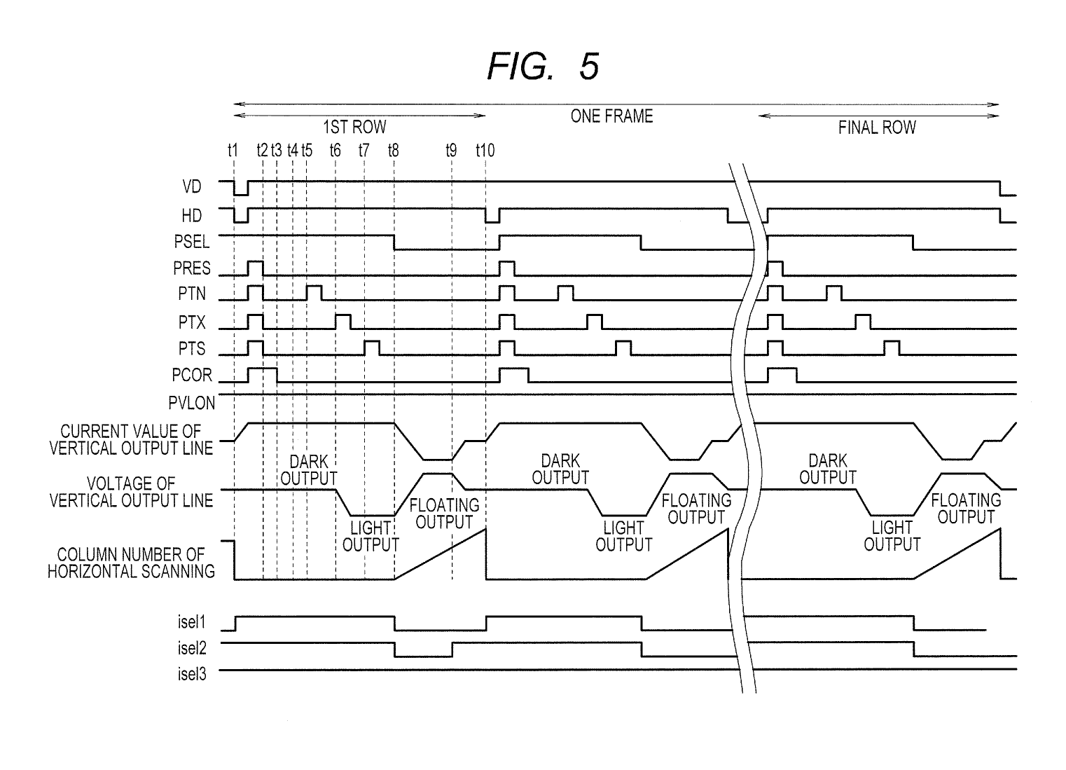

FIG. 5 is a timing chart illustrating an operation example of the solid-state imaging apparatus illustrated in FIG. 4. FIG. 5 is different from FIG. 3 which illustrates the timing chart of the first embodiment, in a point that the value of the electric current passing through the vertical output line 3 is switched in two steps by the signals isel 1 and isel 2 at timings of the time t9 and the time t10. Thereby, the constant current source circuit unit 5 returns to the ON operation in steps, which makes the potential of the vertical output line 3 slowly change and suppresses the variation. In other words, the constant current source circuit unit 5 increases the electric current in steps (two or more steps) when changing the states from the state of supplying no current to the vertical output line 3 to the state of supplying the current to the vertical output line 3. Thereby, the solid-state imaging apparatus can prevent a longitudinal streak and the like due to a kickback current occurring when the current values have been switched in one step, and can minimize the increase of current consumption by controlling the timing of switching the current value in steps. In addition, the potential of the vertical output line 3 becomes sufficiently stable before the current is sampled, which can accordingly prevent a problem such as vertical shading.

### Third Embodiment

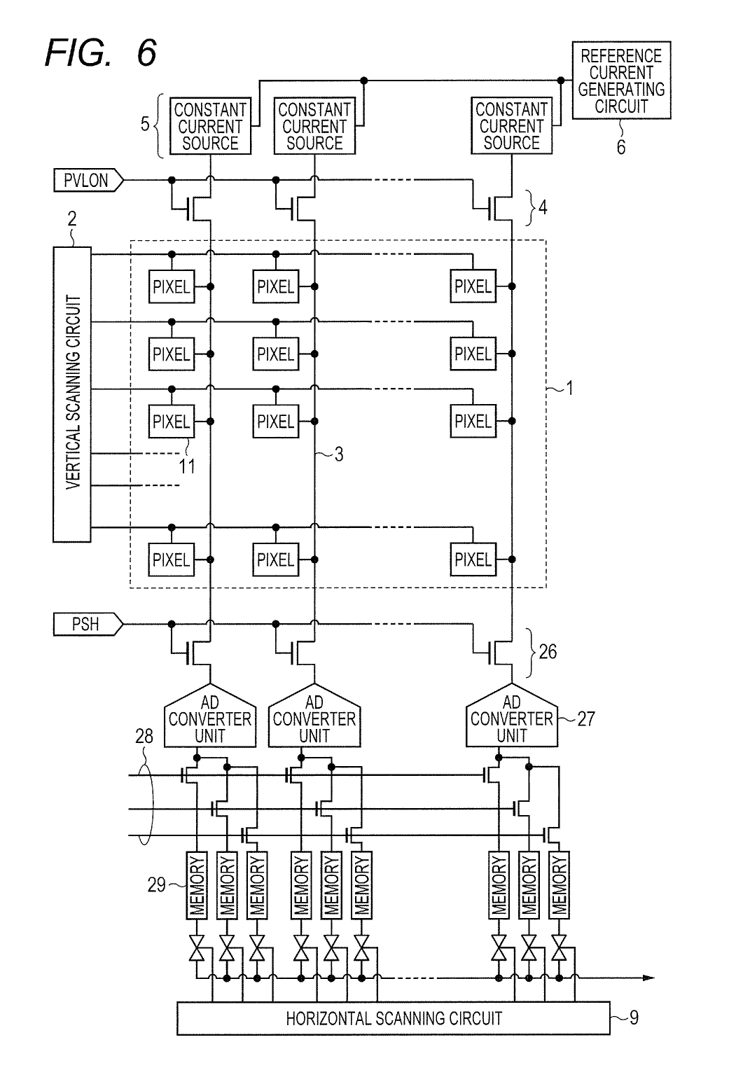

FIG. 6 is a block diagram illustrating a configuration example of a solid-state imaging apparatus of a third embodiment of the present invention. The present embodiment is different from the first embodiment (FIG. 1) in a point that an AD conversion unit (analog-to-digital conversion unit) 27 of a pixel signal and a digital memory unit 29 are provided. The pixel signal of the vertical output line 3 is transferred to the AD conversion unit 27 through the conduction of a column signal transfer switch 26. The AD conversion unit 27 has a not-shown analog memory unit provided in its inner part, and holds the pixel signal therein. Here, an AD conversion unit 27 with 3 bits is illustrated, but the present embodiment is not limited to the AD conversion unit 27 with 3 bits, and may be generalized so as to be an AD conversion unit with n bits. The AD conversion unit 27 converts the pixel signal of the vertical output line 3 from analog into digital form. The converted signal is transferred to the digital memories 29 by the switch control for a pulse sent from a transfer switch driving terminal 28. Here, the AD conversion unit 27 with 3 bits is illustrated, and accordingly the output from each of the AD conversion units 27 is transferred to the three digital memories 29. The horizontal scanning circuit 9 controls the timing of outputting the signal in the digital memories 29 to a signal output line. A digital signal held in the digital memories 29 is output which is connected to a switch that has been selected by the horizontal scanning circuit 9.

For information, if the AD conversion unit 27 has a resolution of n bits, the solid-state imaging apparatus results in having a configuration of having n pieces of the digital memories 29, respectively. Incidentally, the pixel signal which has been read from a pixel array 1 is sampled by an analog memory when the column signal transfer switch 26 is turned ON. Subsequently, the pixel signal is held in the analog memory when the column signal transfer switch 26 is turned OFF. The held pixel signal is converted into a digital signal from an analog signal by the AD conversion unit 27, and the conversion result is transferred to the digital memory 29.

The solid-state imaging apparatus of the present embodiment controls the constant current source circuit unit 5 so as to clear the interception or the reduction of the electric current before the time t1 at which the horizontal synchronizing signal HD is input. In other words, the constant current source circuit unit 5 changes its state from the state of supplying no current to the vertical output line 3 to the state of supplying the current to the vertical output line 3, before the horizontal synchronizing signal HD is input. Other driving methods are similar to those in the first embodiment and the second embodiment, and accordingly the description will be omitted. Thus, the solid-state imaging apparatus of a digital output in which a high-speed image is required must quickly suppress the variation particularly of the vertical output line 3. According to the present embodiment, the potential of the vertical output line 3 becomes sufficiently stable before the signal is sampled, which can accordingly prevent a problem such as vertical shading.

### Fourth Embodiment

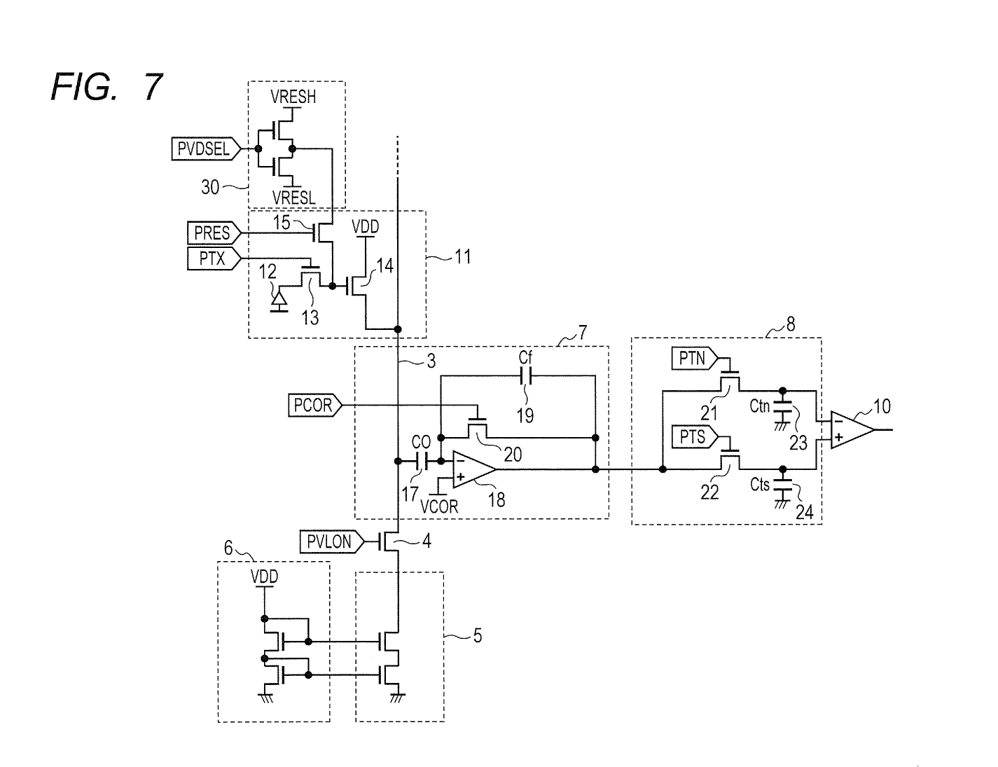

FIG. 7 is a view illustrating a configuration example of a solid-state imaging apparatus of a fourth embodiment of the present invention. The configuration is different from that in FIG. 2 of the first embodiment in a point that a pixel selecting circuit portion 30 is used instead of a row selecting MOS transistor 16 in order to control the conduction between the source electrode of the SFMOS transistor 14 and the vertical output line 3 in the unit pixel 11. The pixel selecting circuit portion 30 is an inverter which outputs a potential VRESH or VRESL; and outputs the potential VRESH when a pulse PVDSEL is set at a low level, and outputs the potential VRESL when the pulse PVDSEL is set at a high level. One block of the pixel selecting circuit portion 30 is arranged in every single column, and the output end of the pixel selecting circuit portion 30 is connected in common with each drain side of a plurality of reset MOS transistors 15. FIG. 7 describes only a typical one pixel.

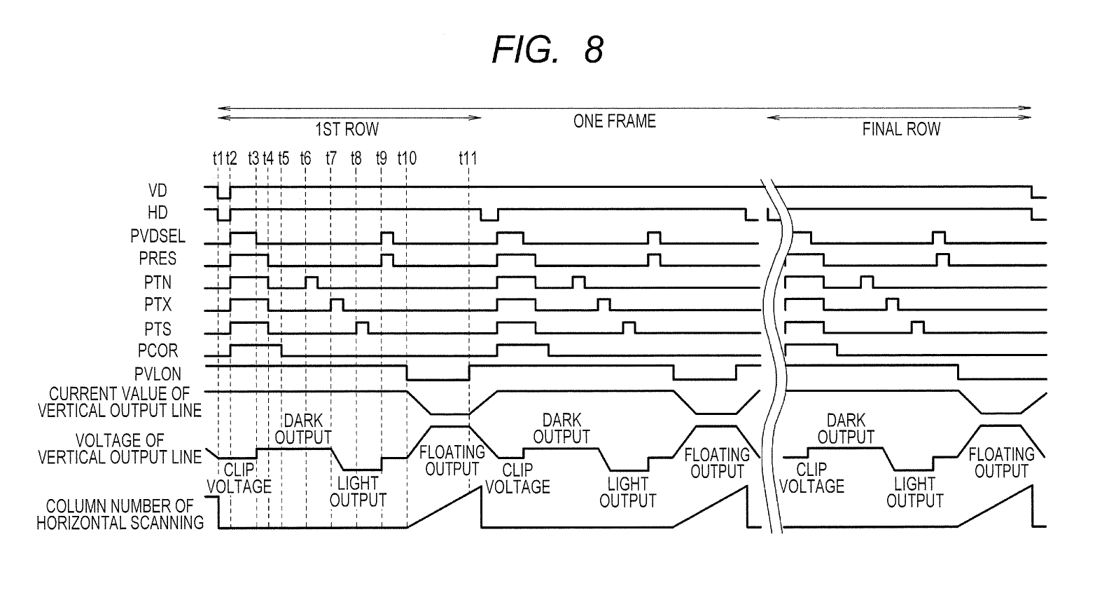

FIG. 8 is a timing chart illustrating an operation example of the solid-state imaging apparatus illustrated in FIG. 7. A vertical synchronizing signal VD specifies a unit section for obtaining signals which show pixels in one frame. A horizontal synchronizing signal HD specifies a unit section for illustrating one horizontal line. Here, each signal is input into both at the time t1, in the beginning.

Firstly, at the time t2, the signals PVDSEL and PRES become a high level, and thereby the gate electrode of the SFMOS transistor 14 is reset at an approximate VRESL. At this time, the gate electrodes of the other SFMOS transistors 14 which are connected to the same column of the vertical output line 3 are also reset at the approximate VRESL. Furthermore, at this time, the electric current passing through the vertical output line 3 is turned into an active state by the SFMOS transistor in a clip circuit (not shown), which has been turned into a conduction state. Thereby, the source electrode of the SFMOS transistor 14 is set at a non-conductive state with respect to the vertical output line 3. Subsequently, at the time t3, the signal PVDSEL becomes a low level, and thereby the gate electrode of the SFMOS transistor 14 is reset at the approximate VRESH. Thereby, the source electrode of the SFMOS transistor 14 becomes a conductive state with respect to the vertical output line 3, and accordingly the SFMOS transistor 14 can be set at a selectable state. Furthermore, at the time t4, the reset MOS transistor 15 becomes a low level from the high level, and the reset state of the gate electrode of the SFMOS transistor 14 is cleared. At this time, a potential corresponding to a dark time is fixed on the gate electrode of the SFMOS transistor 14. The timing of the operation after the first amplifier unit 7 is the same as that of FIG. 3, and accordingly the description will be omitted. As described above, the pixel selecting circuit portion 30 selects the pixel by controlling the gate reset voltage of the SFMOS transistor 14. The pixel selecting circuit 30 can set the pixel at a non-selectable state by supplying the reset voltage VRESL to the gate electrode of the SFMOS transistor 14, and can set the pixel at a selectable state by supplying the reset voltage VRESH to the gate electrode of the SFMOS transistor 14.

As in the above description, in the present embodiment, a constant current is supplied so that the source follower MOS transistors 14 of all pixels of the selected pixel row are turned into a stable state before the pixel signal is output from the source follower MOS transistor 14 of the pixel. As a result, the vertical shading is reduced.

In the present embodiment, at the time t11 in a period of horizontally scanning the previous row, a control switch 4 of the constant current source is turned ON. At this time, all the SFMOS transistors 14 connected to the vertical output line 3 become a non-conductive state, but because the clip circuit (not shown) is in a conductive state, the electric current illustrated in FIG. 8 passes through the vertical output line 3. Thereby, the SFMOS transistors 14 can reach a sufficiently stable level before the potential of the vertical output line 3 is clamped by a clamping capacitor 17. The timing of turning the control switch 4 of the constant current source ON is appropriately determined by the parasitic capacitance which sticks to the constant current source 5, and by the number of the pixels. In addition, a method of adjusting the timing of turning the control switch 4 of the constant current source ON is not only a method of synchronizing the timing with the signal sent from a timing generator, but also may be a method, for instance, of using signals sent from the horizontal scanning circuit 9, as a counter. Thereby, the potential of the vertical output line 3 becomes sufficiently stable before the signal is sampled, though the potential of the vertical output line 3 rapidly changes simultaneously with the feedback of the constant current, and accordingly the solid-state imaging apparatus and the method for driving the solid-state imaging apparatus can prevent a problem such as vertical shading.

### Fifth Embodiment

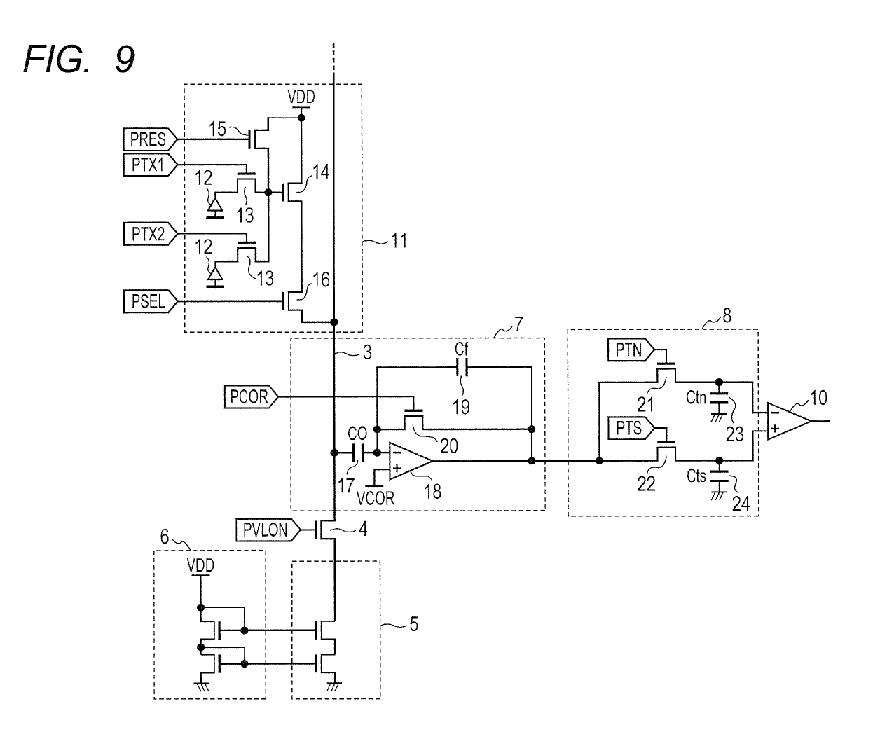

The configuration of the solid-state imaging apparatus of a fifth embodiment of the present invention is the same as that of FIG. 1 described in the first embodiment, and accordingly the description will be omitted. In addition, FIG. 9 illustrates a detailed circuit configuration example of the present embodiment. The configuration of the fifth embodiment is different from that of FIG. 2 described in the second embodiment, in a point that the unit pixel 11 includes two photoelectric conversion units 12, two transfer MOS transistors 13, one SFMOS transistor 14, one reset MOS transistor 15 and one row selecting MOS transistor 16. A plurality of the photoelectric conversion units 12 generates signals by photoelectric conversion. The SFMOS transistor 14 amplifies the signal which has been generated by the photoelectric conversion in the plurality of the photoelectric conversion units 12. A plurality of the transfer MOS transistors 13 transfer a signal which has been generated in the plurality of the respective photoelectric conversion units 12, to the SFMOS transistor 14.

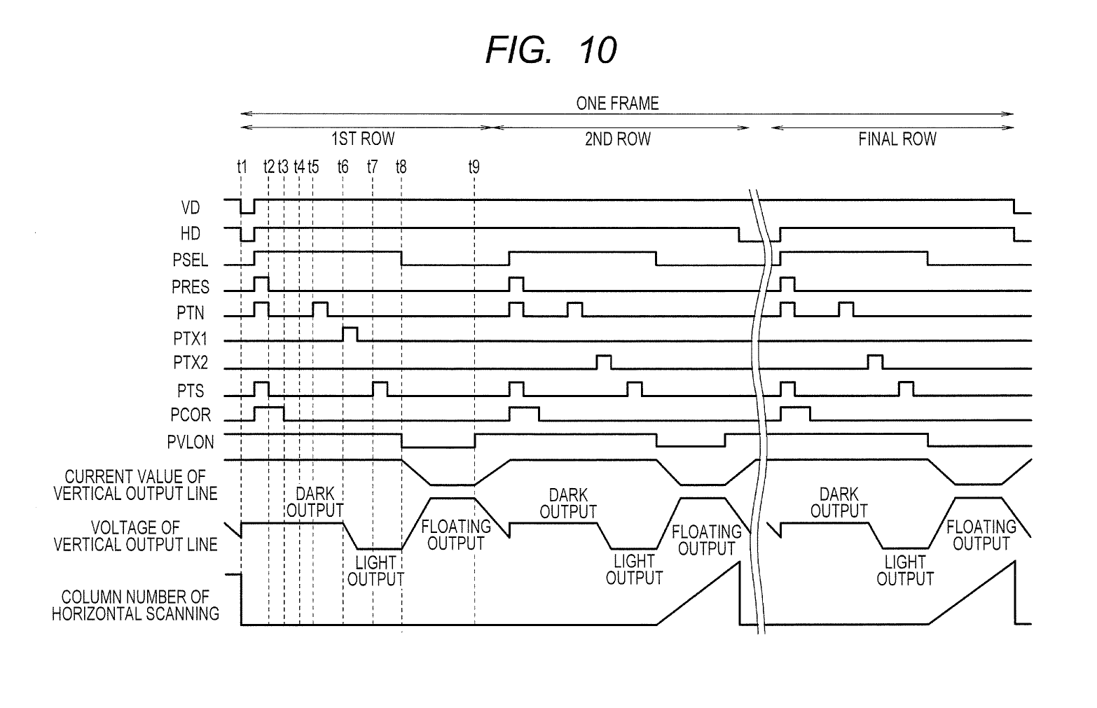

FIG. 10 is a timing chart illustrating an operation example of a solid-state imaging apparatus of the present embodiment. FIG. 10 is different from FIG. 3 of the first embodiment in a point that a horizontal synchronizing signal HD to be input at the time t1 specifies every two rows as a unit section. At the time t8 before the operation of a 2nd row is started, a constant current source circuit unit 5 is turned into an intercepting state again. The constant current source circuit unit 5 changes its state from the state of supplying no current to the vertical output line 3 to the state of supplying the current to the vertical output line 3, before the time t3 of terminating the clamping, whenever the signal has been read from each of the plurality of the photoelectric conversion units 12. Thereby, the constant current source circuit unit 5 returns to the ON operation from the intercepting state after the operation for every row, and thereby the variation of the potential of the vertical output line 3 can be equalized among all of the rows, even when every two rows is horizontally scanned as a unit section. Because of this, the solid-state imaging apparatus and the method for the driving solid-state imaging apparatus can prevent the occurrence of a step or the like, which occurs due to such a phenomenon that the stabilization state of the vertical output line 3 is different depending on the row.

At the time t6 of the 1st row, a signal PTX1 becomes a high level, a transfer MOS transistor 13 corresponding to the signal PTX1 is turned ON, and the signal of the photoelectric conversion units 12 is transferred to the gate electrode of the SFMOS transistor 14. After that, in the 2nd row, a signal PTX2 becomes a high level, the transfer MOS transistor 13 corresponding to the signal PTX2 is turned ON, and the signal of the photoelectric conversion units 12 is transferred to the gate electrode of the SFMOS transistor 14. As in the above description, the signal of the pixel in the 1st row is read by the signal PTX1, and the signal of the pixel in the 2nd row is read by the signal PTX2.

As described above, the solid-state imaging apparatuses and the methods for driving the solid-state imaging apparatuses according to the first to fifth embodiments can reduce vertical shading by reading a signal from the unit pixel 11 in such a state that an electric current passing through the vertical output line 3 is sufficiently stabilized. In addition, the apparatuses and the methods can reduce current consumption by setting the constant current source at the state of supplying no current to the vertical output line 3.

Note that the above embodiments are merely examples how the present invention can be practiced, and the technical scope of the present invention should not be restrictedly interpreted by the embodiments. In other words, the present invention can be practiced in various ways without departing from the technical concept and main features of the invention.

In each of the above described embodiments, the description was focused on the constant current source circuit unit 5 which supplied an electric current to the source follower circuit of the pixel. However, a similar effect to the case of the above described constant current source circuit unit 5 can be obtained also when the present invention has been applied to the other portion. For instance, the similar effect can be obtained by the operation of controlling a current source circuit which drives the first amplifier unit provided on the vertical output line 3 based on the similar concept to that for the constant current source circuit unit 5. In addition, when the sampling and holding circuit 8 includes an amplifier unit, the similar effect can be obtained by controlling the current source which drives the amplifier unit, in the similar way. In other words, the current source circuit portion may be a current source circuit portion for amplifying the signal of the vertical output line 3, and the similar effect can be obtained on the current source circuit portion provided on the vertical output line 3.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-249004, filed Nov. 14, 2011, which is hereby incorporated by reference herein in its entirety.

What is claimed is:

1. A solid-state imaging apparatus comprising:
a plurality of pixels each configured to output a signal generated by a photoelectric conversion via a source follower circuit;
an output line connected to the plurality of pixels;
a current source for supplying a current to the output line; and
a first amplifier unit configured to clamp with a clamping capacitor a signal from the signal line connected to the pixel at a reset state, and to amplify thereafter the signal from the signal line connected to the pixel changed to a non-reset state, wherein
the current source changes from a current non-supplying state to a current supplying state, before a timing of terminating the clamping the signal by the first amplifier unit.

2. The solid-state imaging apparatus according to claim 1, wherein
the current source changes from the current non-supplying state to the current supplying state, at least 1μ second before the timing of terminating the clamping the signal by the first amplifier unit.

3. The solid-state imaging apparatus according to claim 1, wherein
the current source increases, in steps, the current supplied to the output line, at the changing from the current non-supplying state to the current supplying state.

4. The solid-state imaging apparatus according to claim 1, wherein
the pixel includes:
a photoelectric conversion unit configured to generate a charge by the photoelectric conversion;
a source follower MOS transistor configured to output the signal based on the charge generated by the photoelectric conversion; and
a selecting MOS transistor arranged between the source follower MOS transistor and the output line.

5. The solid-state imaging apparatus according to claim 1, wherein
the pixel includes:
a photoelectric conversion unit configured to generate a charge by the photoelectric conversion;
a source follower MOS transistor configured to output the signal based on the charge generated by the photoelectric conversion; and
a pixel selecting circuit portion configured to select the pixel by controlling a gate reset voltage of the source follower MOS transistor.

6. The solid-state imaging apparatus according to claim 1, wherein
the pixel includes:
a plurality of photoelectric conversion units configured to generate charges by the photoelectric conversion;
a source follower MOS transistor configured to output the signal based on the charges generated by the photoelectric conversions by the plurality of photoelectric conversion units; and
a plurality of transfer MOS transistors configured to transfer the signals generated by the plurality of photoelectric conversion units respectively to the source follower MOS transistor.

7. The solid-state imaging apparatus according to claim 6, wherein
the current source changes from a current non-supplying state to a current supplying state, before a timing of terminating the clamping the signal by the first amplifier unit, at each time for reading the signals from the plurality of photoelectric conversion units.

8. A solid-state imaging apparatus comprising:
a plurality of pixels each configured to output a signal generated by a photoelectric conversion via a source follower circuit;
an output line connected to the plurality of pixels; and
a current source for supplying a current to the output line, wherein
the current source changes from a current non-supplying state to a current supplying state, before an input of a horizontal synchronizing signal.

9. The solid-state imaging apparatus according to claim 8, further comprising an analog-to-digital conversion unit configured to convert the signal from the output line from an analog signal into a digital signal.

10. A solid-state imaging apparatus comprising:
a plurality of pixels each configured to output a signal generated by a photoelectric conversion;
an output line connected to the plurality of pixels;
a first amplifier unit configured to clamp with a clamping capacitor a signal from the signal line connected to the pixel at a reset state, and to amplify thereafter the signal from the signal line connected to the pixel changed to a non-reset state; and
a current source for supplying a current for amplifying the signal to the output line, wherein
the current source changes from a current non-supplying state to a current supplying state, before a timing of terminating the clamping the signal by the first amplifier unit.

11. A solid-state imaging apparatus comprising:
a plurality of pixels each configured to output a signal generated by a photoelectric conversion;
an output line connected to the plurality of pixels; and
a current source for supplying a current for amplifying the signal to the output line, wherein
the current source changes from a current non-supplying state to a current supplying state, before a timing of terminating the clamping the signal by the first amplifier unit.
